(19) United States
(12) Patent Application Publication
(10) Pub. No.: US 2008/0262132 A1
(43) Pub. Date: Oct. 23, 2008

(54) NONIONIC SURFACTANTS

(76) Inventors: Thorsten Roloff, Moenchengladbach (DE); Katharina Hoemberg, Hilden (DE); Thomas Schliwka, Bergisch Gladbach (DE); Thomas Mausberg, Haan (DE); Wolfgang H. Breuer, Korschenbrolch (DE); Doug Rhubright, Harleysville, PA (US); Mike Wiggins, Lansdale, PA (US)

Correspondence Address: SYNNESTVEDT & LECHNER LLP, 1101 MARKET STREET, PHILADELPHIA, PA, 19107, US

(21) Appl. No.: 12/048,287

(22) Filed: Mar. 14, 2008

Related U.S. Application Data
(60) Provisional application No. 60/912,467, filed on Apr. 18, 2007.

(51) Int. Cl. C08K 5/1515

(52) U.S. Cl. 524/114

(57) ABSTRACT

A nonionic surfactant for emulsion polymerization is provided, and includes products from the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol, wherein the surfactant is included as an emulsifier in a polymer emulsion. A method for stabilizing an emulsion polymer or polymer dispersion is also provided, including the steps of adding an emulsifier, to an emulsion polylmer or polymer dispersion comprising monomers, in an amount of from about 0.5 to about 10% by weight, based on the total quantity of monomers present, the emulsifier including products from the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol.

### CROSS-REFERENCE TO RELATED APPLICATIONS

This application claims priority under 35 U.S.C. § 119(e) from U.S. Provisional Application No 60/912,467, filed Apr. 18, 2007, the entire disclosure of which is hereby incorporated by reference herein.

### FIELD OF THE INVENTION

This invention relates generally to the nonionic surfactants, and more particularly, to nonionic surfactants as emulsifiers for emulsion polymerization, in which the surfactants are products of the addition of ethylene and/or propylene oxide onto one or more diterpene alcohols selected from the group consisting of abietyl alcohol, dihydroabietyl alcohol, tetrahydroabietyl alcohol and dehydroabietyl alcohol.

### BACKGROUND INFORMATION

Emulsion polymerization is a special polymerization process in which poorly water-soluble monomers are emulsified in water with the aid of emulsifiers and polymerized using water-soluble initiators, such as potassium peroxodisulfate or redox initiators. Anionic and/or nonionic surfactants are the key constituents in this regard. Through the build-up of micelles in the aqueous solution, they guarantee the process of emulsion polymerization.

Alkylphenol-based products, such as the corresponding ethoxylates and ether sulfates, are still regarded as standards in the process of emulsion polymerization, even though more environmentally-friendly products are increasingly becoming of interest. However, there remains a constant demand for new, improved emulsifiers for emulsion polymerization.

DE-A-15 95 393 describes stable aqueous emulsions of special aqueous ternary acrolein/acrylonitrile/ethyl acrylate copolymers which are particularly suitable for the dressing of leather. These copolymers are obtained by copolymerization in aqueous medium using conventional emulsifiers, such as sodium lauryl sulfate for example, and a special redox process, namely in the presence of hydrogen peroxide and ascorbic acid, and optionally in the additional presence of iron(II) salts. In Example 1, a hydroabietyl alcohol ethoxylated with 30 mol ethylene oxide was added on completion of the emulsion polymerization, i.e., to the emulsion itself, expressly for the subsequent stabilization of the latex.

U.S. Pat. No. 2,606,178 relates to the polymerization of styrene by emulsion polymerization. It is specifically stated that nonionic emulsifiers are unsuitable for this purpose (cf. page 2, lines 48-50), and special anionic emulsifiers are proposed, which are obtained as follows: adducts of ethylene or propylene oxide with hydrocarbon acids or alcohols, for example with tall oil, Lorol or hydroabietyl alcohol, are prepared, and then sulfated or sulfonated. The corresponding sulfates or sulfonates are used as anionic emulsifiers.

WO-A-2004/065518 describes special nitrogen-containing substances which correspond to formula (I). They contain a cycoaliphatic hydrocarbyl group, more particularly abietyl, hydroabietyl, dihydroabietyl and tetrahydroabietyl, as the substituent R. The compounds (I) can be obtained by alkoxylating amines with the cycloaliphatic hydrocarbyl groups mentioned. The compounds (I) are used in the recovery of oil and gas from underground formations.

### SUMMARY OF THE INVENTION

Briefly described, according to an aspect of the invention, a nonionic surfactant for emulsion polymerization is provided, and includes products from the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol, wherein the surfactant is included as an emulsifier in a polymer emulsion.

According to another aspect of the invention, a method is provided for stabilizing an emulsion polymer or polymer dispersion, including the steps of adding an emulsifier, to an emulsion polymer or polymer dispersion comprising monomers, in an amount of from about 0.5 to about 10% by weight, based on the total quantity of monomers present, the emulsifier including products from the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol.

### DETAILED DESCRIPTION OF THE INVENTION

The problem addressed by the present invention was to provide compounds which would be suitable (on their own or in admixture with other compounds) as emulsifiers for emulsion polymerization. When used as emulsifiers for emulsion polymerizaton, the compounds particularly ensure that very little coagulate forms.

Another problem addressed by the invention was to provide compounds which, when used as emulsifiers in emulsion polymerization, would lead to polymer dispersions (aqueous latices) with high freeze/thaw stability.

A further problem addressed by the invention was to provide compositions which, when used as emulsifiers in emulsion polymerization, would lead to polymer dispersions (aqueous latices) with high electrolyte stability.

It has now surprisingly been found that products of the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol are eminently suitable as nonionic emulsifiers for emulsion polymerization.

Accordingly, the present invention relates to the use of products of the addition of 3 to 20 mats of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol as nonionic emulsifiers for emulsion polymerization.

Substances to be Used in Accordance with the Invention

Abietic acid (C₂₀H₃₀O₂) is a resin acid which belongs to the diterpenes and which is known to have the following structural formula:

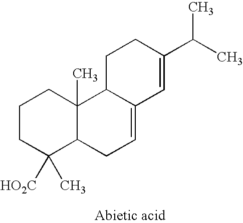

If the carboxyl group (CO₂H) of abietic acid is reduced to the alcohol group (CH₂OH), the corresponding alcohol is obtained. Abietyl alcohol (C₂₀H₃₂O) is thus characterized by the following structure:

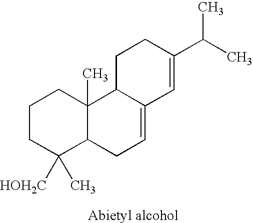

If the double bonds of abietyl alcohol are partly or completely hydrogenated, dihydroabietyl alcohol C₂₀H₃₄O (two isomeric forms, depending on which double bond is hydrogenated) or tetrahydroabietyl alcohol C₂₀H36O is obtained. If abietyl alcohol is dehydrogenated, dehydroabietyl alcohol is obtained.

All the species mentioned, i.e., abietyl alcohol, dihydroabietyl alcohol, tetrahydroabietyl alcohol and dehydroabietyl alcohol, are accessible to ethoxylation or propoxylation at the alcoholic group.

As already mentioned, products of the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol are used in accordance with the invention as (nonionic) emulsifiers for emulsion polymerization. The compounds mentioned may be used individually or in the form of a mixture. One example of a particularly suitable mixture includes the addition products of 3 to 20 mols of ethylene oxide onto technical mixtures which predominantly contain hydrogenated forms of abietyl alcohol. Addition products of 5 to 15 mols of ethylene oxide onto ABITOL®E (obtainable from Eastman) are most particularly preferred.

The compounds to be used in accordance with the invention may be used as sole emulsifiers (primary emulsifiers) in emulsion polymerization. However, the compositions according to the invention may also be used together with anionic, other nonionic, or cationic emulsifiers. In one preferred embodiment, the nonionic emulsifiers according to the invention are used in combination with anionic emulsifiers, and more particularly, anionic emulsifiers selected from the group of fatty alcohol sulfates, fatty alcohol ether sulfates and sulfosuccinates.

The compounds to be used in accordance with the invention are used as emulsifiers in emulsion polymerization in a quantity of 0.5 to 10% by weight, preferably in a quantity of 1 to 5% by weight, and more particularly, in a quantity of 1 to 3% by weight, based on the total quantity of monomers used in the emulsion polymerization.

The compounds to be used in accordance with the invention are generally suitable for use as emulsifiers in the production of aqueous latices, by which are meant aqueous emulsions or dispersions of polymers and/or copolymers which are normally obtainable by emulsion polymerization. Basically, there are no particular restrictions as to the nature of the polymers and copolymers in these aqueous latices. However, polymers or copolymers based on the following monomer units are particularly preferred: acrylic acid, acrylates, butadiene, methacrylic acid, methacrylates, styrene, vinyl acetate and versatic acid vinyl ester.

The compounds to be used in accordance with the invention provide aqueous latices with, in particular, high freeze/thaw stability and electrolyte stability. Another effect of the compounds to be used in accordance with the invention is that plastic films produced from the latices are distinguished by high resistance to alkalis.

The “freeze/thaw” stability is a parameter familiar to the relevant expert. The principle of determining freeze/thaw stability can be found in ISO 1147. Determining the freeze/thaw stability of aqueous latices to ISO 1147 is carried out by cooling aqueous latices to various minimum temperatures (specifically −5, −10 and −15° C.) and maintaining at those temperatures for 16 hours. The latices are then heated to room temperature (about +23° C.) and kept at that temperature for 8 hours. The latices are then examined for coagulate formation. If there is no coagulate formation, i.e., if the latex dispersion was stable to coagulate formation, the described cycle (cooling and thawing) is repeated and the latices re-examined for coagulate formation. This freezing/thawing cycle is repeated until either coagulate formation is observed, or a maximum of 5 cycles is reached without coagulate formation being achieved. If the dispersion is still stable after cooling 5 times, the process is repeated with the next lowest temperature. For determining their freeze/thaw stability, the aqueous latices are preferably used in quantities of 50 to 100 grams.

“Electrolyte stability” in the context of the present invention means that a polymer dispersion does not coagulate after the addition of 1% by weight or 10% by weight aqueous solutions of inorganic salts with mono- to trivalent cations (for example NaCl, CaCl₂ or Al₂(SO₄)₃) in a ratio by volume of 50:50 (polymer dispersion:salt solution). Coagulation in this context means the agglomeration of inadequately stabilized latex particles. Coagulate formation is visually evaluated.

“Alkali resistance” in the context of the present invention means that dried plastic films or coatings show very little, if any, clouding on storage in a 4% NaOH solution.

The production of plastic films from aqueous latices is carried out in a conventional manner. Aqueous latices are spread out in a thin layer and the layer formed is subjected to drying. The latex is normally spread out on a hard surface, for example by knife coating. Layers between 100 and 2,000 μm in thickness are typically formed. The layer can also be formed by other known methods besides knife coating, for example by spray coating, brush coating and dip coating.

In one embodiment, additives of the type normally used for coating purposes are added to the aqueous latices before they are spread out. Examples of such additives include inorganic and organic pigments, and fillers, such as carbonates, silicon dioxide, silicas, silicates and sulfates.

### EXAMPLES

### Substances Used

The substances referred to in the following as ABITOL-5EO, ABITOL-10EO and ABITOL-15EO were produced by addition of 5, 10 and 15 mol, respectively, of ethylene oxide (EO) onto the commercially obtainable product ABITOL®E (Eastman). The substances are characterized as follows:

ABITOL-5EO: hydroxyl value 99.0; melting range 24-27° C.; specific gravity 1.013 g/cm³;

ABITOL-10EO: hydroxyl value 71.8, melting range 28-31° C., specific gravity 1.038 g/cm³;

ABITOL-15EO: hydroxyl value 57.1, melting range 31-33° C., specific gravity=1.045 g/cm³; and

DISPONIL®FES 32: fatty alcohol ether sulfate=4EO; sodium salt (available from Cognis).

### Test Methods

### Coagulate

This method is used to determine the coagulate content formed during the polymerization process. After polymerization, the dispersion obtained is filtered through a Loeffler 80 μm-mesh sieve bag of known tare weight. After drying, the sieve bag is re-weighed, the difference representing the weight of coagulate. The coagulate content is expressed in percent, based on the theoretical solids content of the dispersion. The theoretical solids content is calculated from the sum total of all the solid constituents which do not evaporate at temperatures below 150° C.

### Solids Content

This method is used to determine the solids content of a product of a product solution/dispersion. In many cases, conclusions can thus be drawn as to the active substance, and hence the effectiveness of the particular product. The experimentally determined solids content can differ from the theoretical. In addition, comparison of the experimentally determined solids content with the theoretically calculated solids content can provide an indication of the conversion.

For experimentally determining the solids content, 5 grams (±0.2 grams) of the substance to be tested is carefully weighed on a Sartorius type 709301 dry residue balance and dried for 20 minutes at 150° C. The result is expressed as percent dry residue.

### Viscosity

This method is used to determine the flow properties of latices that are relevant to their production, handling and processing. The latex to be tested is poured into a 400 ml glass beaker (shallow form), and heated to the measuring temperature. The measurement is carried out using the spindle required for the measuring range which is introduced obliquely, while rotating into the sample in order to prevent air bubbles from becoming trapped below the measuring element. The spindle is introduced until the indentation is level with the latex surface. The measurement is carried out at 20 r.p.m. After 60 seconds, the scale value is read and used to calculate the viscosity. The result represents the viscosity in mPas and is expressed together with the spindle number and the rotational speed: η=viscosity in mPas, F=spindle factor at 20 r.p.m., and S=scale value.

### pH Value

This method is used to the determine the pH value of a polymer dispersion. A pre-calibrated pH meter is used for the measurement, which is carried out in undiluted dispersions.

### Particle Size

This method is used to determine the mean particle size range in colloidal particle systems by automatic measurement. The measurement is carried out with a Beckman Coulter N5. The standard measuring angle is 90°. One or two drops of the liquid to be tested are introduced into a glass beaker and adjusted to the measuring concentration with demineralized water. The demineralized water is added from a non-reusable PE syringe through a filter (blue, pore size 0.2 μm).

The sample thus diluted is placed in a cell and inserted into the test slot of the analyzer. Care must be taken not to touch the lower part of the cell because finger prints lead to false results. Before the measurement is started, the cell should be left standing in the analyzer for three minutes. The measurement should last 200 seconds. Basically, a double measurement has to be carried out. The result is expressed as the mean particle diameter in nm

### Alkali Resistance

This method provides information on the sensitivity of polymer films to alkaline media. Using a drawing rule (gap height 100 μm), a wet film is drawn onto a glass specimen holder. The wet films are then dried for 72 hours at room temperature on a horizontally leveled surface. The specimen holders with the dried films are then placed upright in a 4% sodium hydroxide solution and used for evaluation after 3, 6, 24, 48 or x hours. Evaluation is based on a 6-point scale. The result is expressed as the corresponding number. The point scale is as follows:
0=film is clear and unchanged
1=film is locally slightly clouded
2=film is slightly clouded
3=film is clouded but still transparent
4=film has turned locally white
5=film is white.

### Freeze/Thaw Stability

This method is intended to provide information on the storage properties of polymer dispersions at varying storage temperatures. Quantities of 50 grams of the dispersion to be tested are poured into a 125 ml wide-necked screw-top bottle, placed in a conditioning chamber and cooled to −5° C. over a period of 16 hours. The dispersion is then re-heated to room temperature over a period of 8 hours. On reaching room temperature, the dispersion is visually evaluated for stability (1 cycle). If the dispersion is stable, this process is repeated until the dispersion becomes unstable, up to four times. Dispersions which are still stable after cooling 5 times are tested in the same way at a lower temperature (reduced by 5° C., but not below −20° C.). The result is expressed as the number of cycles at the particular temperature at which the dispersion became unstable or as a “✓” if the dispersion is still stable after five cycles.

### Electrolyte Stability

Table 1 below illustrates, inter alias, the effects observed when various salt solutions were added to the solutions. The effects represent the results of the electrolyte stability test. To this end, the following investigations were carried out.

Quantities of 10 ml of the particular dispersion (see Table 1) were mixed with 10 ml of the following salt solutions:
1% NaCl;
10% NaCl;
1% CaCl₂;
10% CaCl₂;
1% Al₂(SO₄)₃; and
10% Al₂(SO₄)₄.
   If the dispersion remained stable (visual evaluation), i.e., if electrolyte stability was achieved, this is indicated by a “✓” in Table 1. If the dispersion was found to be unstable through coagulate formation (visual evaluation), this is indicated by an “x”.

### Emulsion Polymerization Examples

No nonionic emulsifier was used in Example 1 (Comparison Example).

NP10 (addition product of 10 mol ethylene oxide onto alkylphenol) was used as the nonionic emulsifier in Example 2 (Comparison Example).

Examples 3 to 5 (according to the invention) illustrate the use of the compounds according to the invention, ABITOL-5EO, ABITOL-10EO and ABITOL-15EO as nonionic emulsifiers.

“DI water” means deionized water. “DR” means dry residue. The quantities in the second column of the Examples are parts by weight; the third column shows the associated components:

| | | |
|---|---|---|
| Starting reactor contents | 0.79 | DISPONIL FES 32 |
| | 189.13 | DI water |
| Addition 1 | 94.40 | Styrene |
| Pre-emulsion | 221.70 | Butyl acrylate |
| | 151.00 | Methyl methacrylate |
| | 4.70 | Methacrylic acid |
| | 266.19 | DI water |
| | 11.65 | DISPONIL FES 32 |
| Addition 2 | 2.36 | Ammonium persulfate |
| Initiator solution | 58.08 | DI water |
| Total | 1000.00 | Polymer dispersion, |
| | | Theoretical DR: 48.5% |

### Production of the Pre-Emulsions:

The demineralized water was weighed into a 400 ml glass beaker together with the emulsifiers, and homogenized with a magnetic stirrer. The monomers were weighed into an 800 ml glass beaker below the outlet. The aqueous phase of the pre-emulsion was introduced into the pre-emulsion flask. The monomers were then introduced into the flask with stirring.

### Reactor Preparation:

The starting reactor contents were mixed in a 250 ml glass beaker and transferred to the reactor. The entire apparatus was then purged with nitrogen for at least 15 minutes. The stream of nitrogen was maintained throughout the reaction. The thermostat was set to 85° C. and heated without circulation.

### Procedure:

After purging with nitrogen, the heating circuit was opened. At an internal reactor temperature of 80° C., 15. ml of the initiator solution and 40 ml of the pre-emulsion were added, followed by stirring for 15 minutes at 80° C. After this time, the remaining initiator solution and the pre-emulsion were added. The addition time was 180 minutes and was followed by post-polymerization for 30 minutes at a jacket temperature increased by 3° C. On completion of the reaction, the contents were cooled to <30° C. and a pH of 8.2 to 8.8 was adjusted with 12.5% ammonia solution.

### Example 2

| | | |
|---|---|---|
| Starting reactor contents | 0.79 | DISPONIL FES 32 |
| | 189.13 | DI water |
| Addition 1 | 94.40 | Styrene |
| Pre-emulsion | 221.70 | Butyl acrylate |
| | 151.00 | Methyl methacrylate |
| | 4.70 | Methacrylic acid |
| | 259.10 | DI water |
| | 7.08 | DISPONIL NP 10 |
| | 11.65 | DISPONIL FES 32 |
| Addition 2 | 2.36 | Ammonium persulfate |
| Initiator solution | 58.08 | DI water |
| Total | 1000.00 | Polymer dispersion, |
| | | theoretical DR: 48.5% |

The procedure as described in Example 1 was followed.

### Example 3

| | | |
|---|---|---|
| Starting reactor contents | 0.79 | DISPONIL FES 32 |
| | 189.13 | DI water |
| Addition 1 | 94.40 | Styrene |
| Pre-emulsion | 221.70 | Butyl acrylate |
| | 151.00 | Methyl methacrylate |
| | 4.70 | Methacrylic acid |
| | 259.10 | DI water |
| | 7.08 | ABITOL 5 EO |
| | 11.65 | DISPONIL FES 32 |
| Addition 2 | 2.36 | Ammonium persulfate |
| Initiator solution | 58.08 | DI water |
| Total | 1000.00 | Polymer dispersion, |
| | | theoretical DR: 48.5% |

The procedure as described in Example 1 was followed.

### Example 4

| | | |
|---|---|---|
| Starting reactor contents | 0.79 | DISPONIL FES 32 |
| | 189.13 | DI water |
| Addition 1 | 94.40 | Styrene |
| Pre-emulsion | 221.70 | Butyl acrylate |
| | 151.00 | Methyl methacrylate |
| | 4.70 | Methacrylic acid |
| | 259.10 | DI water |
| | 7.08 | ABITOL 10 EO |
| | 11.65 | DISPONIL FES 32 |
| Addition 2 | 2.36 | Ammonium persulfate |
| Initiator solution | 58.08 | DI water |
| Total | 1000.00 | Polymer dispersion, |
| | | theoretical DR: 48.5% |

The procedure as described in Example 1 was followed.

### Example 5

| | | |
|---|---|---|
| Starting reactor contents | 0.79 | DISPONIL FES 32 |
| | 189.13 | DI water |
| Addition 1 | 94.40 | Styrene |
| Pre-emulsion | 221.70 | Butyl acrylate |
| | 151.00 | Methyl methacrylate |
| | 4.70 | Methacryclic acid |
| | 259.10 | DI water |
| | 7.08 | ABITOL 15 EO |
| | 11.65 | DISPONIL FES 32 |
| Addition 2 | 2.36 | Ammonium persulfate |
| Initiator solution | 58.08 | DI water |
| Total | 1000.00 | Polymer dispersion, |
| | | theoretical DR: 48.5% |

The procedure as described in Example 1 was followed.

The experimental data of the Examples in relation to the carrying out of the tests described above can be found in Table 1.

TABLE 1

| | Example 1 | Example 2 | Example 3 | Example 4 | Example 5 |
|---|---|---|---|---|---|
| | (comparison) | (comparison) | (invention) | (invention) | (invention) |
| Coagulate [%] | 0.11 | 0.12 | 0.04 | 0.04 | 0.07 |
| Solids [%] | 47.2 | 47.9 | 47.8 | 48.4 | 48.1 |
| Viscosity [mPas] | 370 | 340 | 382 | 360 | 332 |
| pH value | 8.2 | 8.4 | 8.4 | 8.4 | 8.2 |
| Particle size [nm] | 131 | 134 | 133 | 158 | 138 |
| Electrolyte stability | | | | | |
| 1% NaCl | ✓ | ✓ | ✓ | ✓ | ✓ |
| 10% NaCl | x | ✓ | ✓ | ✓ | ✓ |
| 1% CaCl₂ | x | ✓ | ✓ | ✓ | ✓ |
| 10% CaCl₂ | x | x | X | x | x |
| 1% Al₂(SO₄)₃ | x | x | X | x | x |
| 10% Al₂(SO₄)₃ | x | x | X | x | x |
| Alkali resistance | 0 | 0 | 0 | 0 | 0 |
| Freeze/thaw | | | | | |
| stability | | | | | |
| −5° C. | | | ✓ | ✓ | ✓ |
| −10° C. | | | ✓ | 1 | ✓ |
| −15° C. | | | 2 | 1 | 1 |

What is claimed is:

1. A nonionic surfactant for emulsion polymerization, comprising:
products from the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol, wherein the surfactant is included as an emulsifier in a polymer emulsion.

2. The surfactant according to claim 1, wherein 5 to 15 mols of ethylene oxide are used.

3. The surfactant according to claim 1, wherein the nonionic emulsifiers are used in combination with anionic emulsifiers.

4. The surfactant according to claim 3, wherein the anionic emulsifiers are selected from the group consisting of fatty alcohol sulfates, fatty alcohol ether sulfates and sulfosuccinates.

5. A method for stabilizing an emulsion polymer or polymer dispersion, comprising the steps of:
adding an emulsifier, to an emulsion polymer or polymer dispersion comprising monomers, in an amount of from about 0.5 to about 10% by weight, based on the total quantity of monomers present, the emulsifier comprising:
products from the addition of 3 to 20 mols of ethylene and/or propylene oxide onto 1 mol of one or more diterpene alcohols selected from the group consisting of abietyl alcohol, dihydroabietyl alcohol, tetrahydroabietyl alcohol and dehydroabietyl alcohol.

6. The method according to claim 5, wherein the emulsifier is added in an amount of from about 1 to about 5% by weight, based on the total quantity of monomers present.

7. The method according to claim 5, wherein the emulsifier is added in an amount of from about 1 to about 3% by weight, based on the total quantity of monomers present.
